(19) United States
(12) Patent Application Publication
(10) Pub. No.: US 2007/0112895 A1
(43) Pub. Date: May 17, 2007

(54) Block-based incremental backup

(75) Inventors: Matthew A. Ahrens, San Francisco, CA (US); Mark J. Maybee, Boulder, CO (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/432,067

(22) Filed: May 11, 2006

Related U.S. Application Data
(60) Provisional application No. 60/733,751, filed on Nov. 4, 2005.

(51) Int. Cl. G06F 17/30

(52) U.S. Cl. 707/204

(57) ABSTRACT

A method for backing up a file system, including obtaining a first indirect block comprising a first block pointer, obtaining a first birth time from the first block pointer, determining whether the first birth time is subsequent to a time of a last backup, and backing up a first block referenced by the first block pointer, if the first birth time is subsequent to the time of the last backup.

### CROSS REFERENCE TO RELATED APPLICATIONS

This application claims benefit of U.S. Provisional Application Ser. No. 60/733,751 filed on Nov. 4, 2005, entitled “Block-based Incremental Backup” in the names of Matthew A. Ahrens and Mark J. Maybee.

The present application contains subject matter that may be related to the subject matter in the following U.S. patent applications, which are all assigned to a common assignee: “Method and Apparatus for Self-Validating Checksums in a File System” (application Ser. No. 10/828,573) filed on Apr. 24, 2004; “Method and Apparatus for Dynamic Striping” (application Ser. No. 10/828,677) filed on Apr. 21, 2004; “Method and Apparatus for Vectored Block-Level Checksum for File System Data Integrity” (application Ser. No. 10/828,715) filed on Apr. 21, 2004; “Method and Apparatus for Identifying Tampering of Data in a File System” (application Ser. No. 10/853,874) filed on May 26, 2004; “Method and System for Detecting and Correcting Data Errors Using Checksums and Replication” (application Ser. No. 10/853,837) filed on May 26, 2004; “Method and System for Detecting and Correcting Data Errors Using Data Permutations” (application Ser. No. 10/853,870) filed on May 26, 2004; “Method and Apparatus for Compressing Data in a File System” (application Ser. No. 10/853,868) filed on May 26, 2004; “Gang Blocks” (application Ser. No. 10/919,878) filed on Aug. 17, 2004; “Method and Apparatus for Enabling Adaptive Endianness” (application Ser. No. 10/919,886) filed on Aug. 17, 2004; and “Automatic Conversion of All-Zero Data Storage Blocks into File Holes” (application Ser. No. 10/853,915) filed on May 26, 2004.

### BACKGROUND

File systems typically store large amounts of data. To ensure that the data stored in a file system can be recovered in the event of a file system failure, corruption of data, etc., file system data is typically backed up on a frequent basis. Backing up data in a file system involves creating a copy of data that is to be backed up and storing the copied data in a separate location from the file system disks. Typically, file system data is copied from disks to secondary storage (e.g., tapes, drives, etc.).

In general, file system data is backed up on a regular schedule (i.e., backups occur on a periodic basis when the timing for performing a backup is most convenient based on the use of the file system). However, for large file systems that stores increasing amounts of data, backing up the entire file system periodically is time consuming and difficult to manage. Specifically, the amount of time necessary to accomplish backups impinges upon the available production time for the file system.

Most backup technologies employ a common solution to this problem, which involves performing one or more incremental backups in between the times that a full backup of the file system is performed. An incremental backup copies only the data that has been modified or changed since the last backup was performed to secondary storage. For example, suppose a full-backup of a file system is performed on Day 1. On Day 2, only the data that has been modified since the time of the full backup on Day 1 is copied to secondary storage.

Subsequently, on Day 3, only the data that has been modified since Day 2 is backed up. This process continues until a convenient time to perform another full back up is obtained. Once a full back up is performed, the process is repeated by performing one or more incremental backups until a subsequent full backup is performed on the file system.

Typically, the level of granularity available for determining delta changes that have occurred since the last full backup is a file. As a result, if a particular file has changed, the entire contents of the file is included in the incremental backup. The file properties include data stamps indicating last modification times and comparing the time stamps against the time and date of the last backup will determine whether the particular files is to be backed up.

In some instances, when the incremental changes since the last full back up include large amounts of data, discovering the data that needs to be incrementally backed up can be a time-consuming and difficult task. Conventionally, backup technologies discover the changed files by reading the entire directory structure of the file system. Further, some incremental backups can be just as large as a full backups, depending on the level of activity associated with the file system.

### SUMMARY

In general, in one aspect, the invention relates to a method for backing up a file system, comprising obtaining a first indirect block comprising a first block pointer, obtaining a first birth time from the first block pointer, determining whether the first birth time is subsequent to a time of a last backup, and backing up a first block referenced by the first block pointer, if the first birth time is subsequent to the time of the last backup.

In general, in one aspect, the invention relates to a computer usable medium comprising computer readable program code embodied therein for causing a computer system to: obtain a first indirect block comprising a first block pointer, obtain a first birth time from the first block pointer, determine whether the first birth time is subsequent to a time of a last backup, and back up a first block referenced by the first block pointer, if the first birth time is subsequent to the time of the last backup.

In general, in one aspect, the invention relates to a system for backing up a file in a file system, comprising: the file comprising a plurality of data blocks and at least one indirect block, wherein the indirect block comprises a birth time associated with at least one of the plurality of data blocks, and a root block comprising a birth time associated with the at least one indirect block, a storage pool allocator configured to store the plurality of data blocks, the at least one indirect block, and the root block on a disk, wherein the root block is backed up if a birth time associated with the root block is after a time of a last backup, wherein the at least one indirect block is backed up if a birth time of the at least one indirect block is after the time of the last backup, and wherein only the ones of the plurality of data blocks having a birth time after the time of the last backup are backed up.

Other aspects of the invention will be apparent from the following description and the appended claims.

### BRIEF DESCRIPTION OF DRAWINGS

FIG. 1 shows a system architecture in accordance with an embodiment of the invention.

FIG. 2 shows a storage pool allocator in accordance with an embodiment of the invention.

FIG. 3 shows a hierarchical data configuration in accordance with an embodiment of the invention.

FIG. 4 shows a flow chart for block-based incremental backup in accordance with an embodiment of the invention.

FIG. 5 shows an example of block-based incremental backup in accordance with an embodiment of the invention.

FIG. 6 shows a computer system in accordance with an embodiment of the invention.

### DETAILED DESCRIPTION

Specific embodiments of the invention will now be described in detail with reference to the accompanying figures. Like elements in the various figures are denoted by like reference numerals for consistency. Further, the use of “ST” in the drawings is equivalent to the use of “Step” in the detailed description below.

In the following detailed description of one or more embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, embodiments of the invention relate to a method and apparatus for block-based incremental backup of a file system. More specifically, embodiments of the invention are directed towards backing-up only those parts of the file system that have changed or been modified since the last backup occurred. Further, embodiments of the invention include functionality to rapidly discover and backup the portions of a file (i.e., the particular blocks) that have changed.

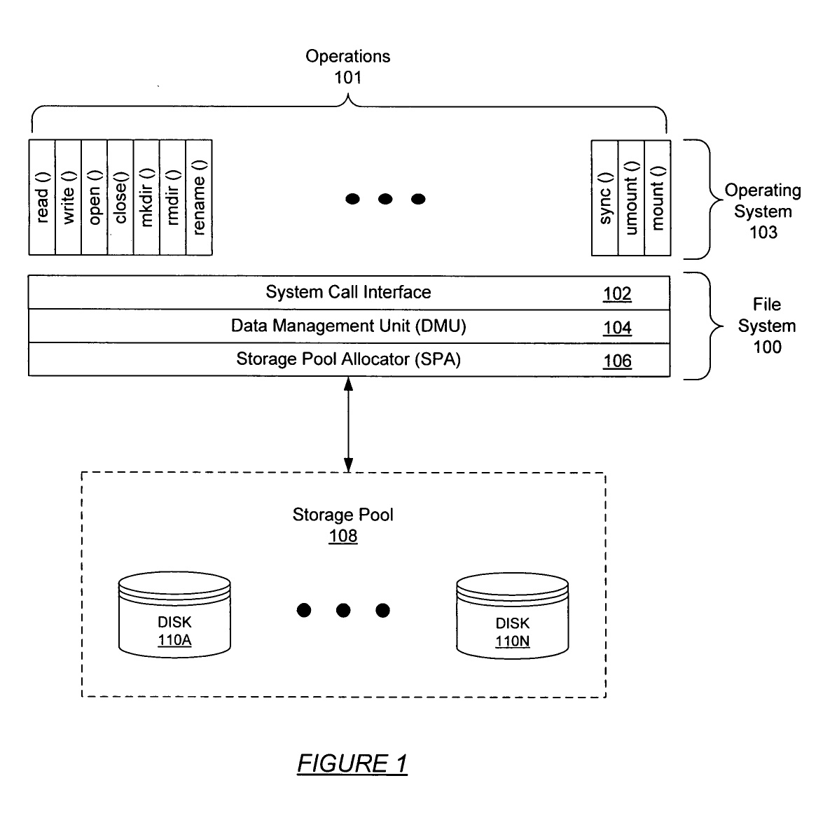

FIG. 1 shows a system architecture in accordance with one embodiment of the invention. The system architecture includes an operating system (103) interacting with a file system (100), which in turn interfaces with a storage pool (108). In one embodiment of the invention, the file system (100) includes a system call interface (102), a data management unit (DMU) (104), and a storage pool allocator (SPA) (106).

The operating system (103) typically interfaces with the file system (100) via a system call interface (102). The operating system (103) provides operations (101) for users to access files within the file system (100). These operations (101) may include read, write, open, close, etc. In one embodiment of the invention, the file system (100) is an object-based file system (i.e., both data and metadata are stored as objects). More specifically, the file system (100) includes functionality to store both data and corresponding metadata in the storage pool (108). Thus, the aforementioned operations (101) provided by the operating system (103) correspond to operations on objects.

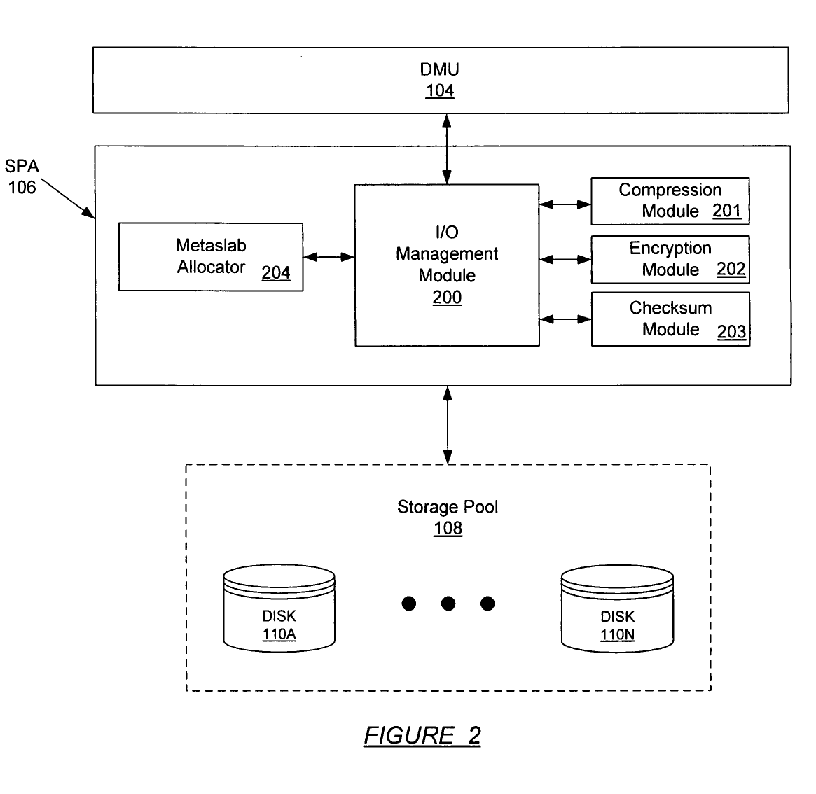

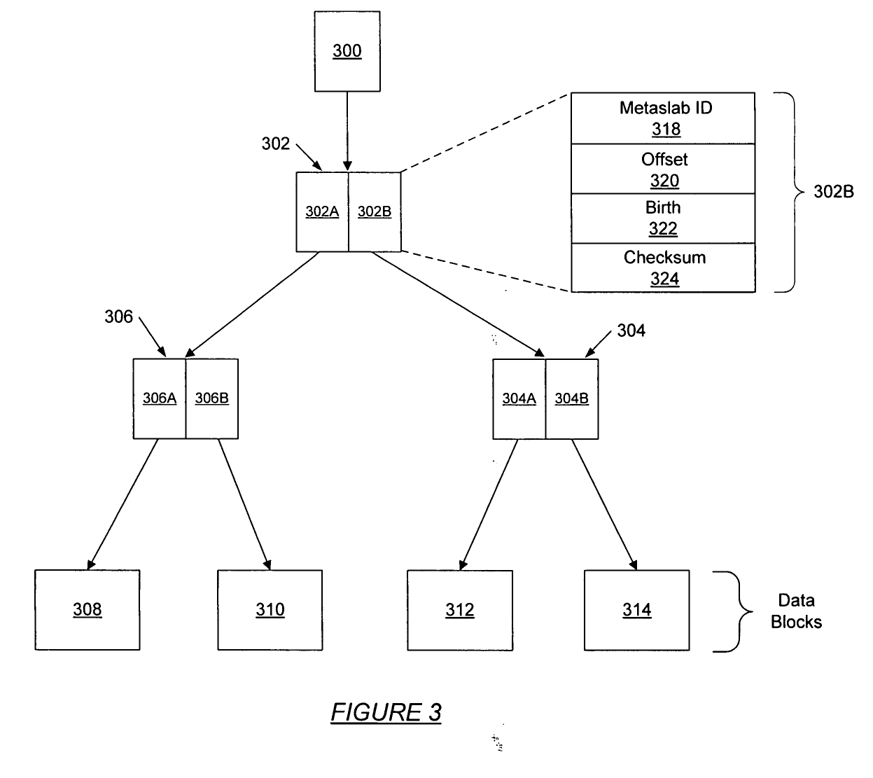

More specifically, in one embodiment of the invention, a request to perform a particular operation (101) (i.e., a transaction) is forwarded from the operating system (103), via the system call interface (102), to the DMU (104). In one embodiment of the invention, the DMU (104) translates the request to perform an operation on an object directly to a request to perform a read or write operation at a physical location within the storage pool (108). More specifically, the DMU (104) represents the objects as data blocks and indirect blocks as described in FIG. 3 below. Additionally, in one embodiment of the invention, the DMU (104) includes functionality to group related work (i.e., modifications to data blocks and indirect blocks) into I/O requests (referred to as a “transaction group”) allowing related blocks to be forwarded to the SPA (106) together. The SPA (106) receives the transaction group from the DMU (104) and subsequently writes the blocks into the storage pool (108). The operation of the SPA (106) is described in FIG. 2 below.

In one embodiment of the invention, the storage pool (108) includes one or more physical disks (disks (110A-110N)). Further, in one embodiment of the invention, the storage capacity of the storage pool (108) may increase and decrease dynamically as physical disks are added and removed from the storage pool. In one embodiment of the invention, the storage space available in the storage pool (108) is managed by the SPA (106).

FIG. 2 shows the SPA (106) in accordance with one embodiment of the invention. The SPA (106) may include an I/O management module (200), a compression module (201), an encryption module (202), a checksum module (203), and a metaslab allocator (204). Each of these aforementioned modules are described in detail below.

As noted above, the SPA (106) receives transactions from the DMU (104). More specifically, the I/O management module (200), within the SPA (106), receives transactions from the DMU (104) and groups the transactions into transaction groups in accordance with one embodiment of the invention. The compression module (201) provides functionality to compress larger logical blocks (i.e., data blocks and indirect blocks) into smaller segments, where a segment is a region of physical disk space. For example, a logical block size of 8 K bytes may be compressed to a size of 2 K bytes for efficient storage. Further, in one embodiment of the invention, the encryption module (202) provides various data encryption algorithms. The data encryption algorithms may be used, for example, to prevent unauthorized access. In one embodiment of the invention, the checksum module (203) includes functionality to calculate a checksum for data (i.e., data stored in a data block) and metadata (i.e., data stored in an indirect block) within the storage pool. The checksum may be used, for example, to ensure data has not been corrupted.

As discussed above, the SPA (106) provides an interface to the storage pool and manages allocation of storage space within the storage pool (108). More specifically, in one embodiment of the invention, the SPA (106) uses the metaslab allocator (204) to manage the allocation of storage space in the storage pool (108).

In one embodiment of the invention, the storage space in the storage pool (108) is divided into contiguous regions of data, i.e., metaslabs. The metaslabs may in turn be divided into segments (i.e., portions of the metaslab). The segments may all be the same size, or alternatively, may be a range of sizes. The metaslab allocator (204) includes functionality to allocate large or small segments to store data blocks and indirect blocks. In one embodiment of the invention, allocation of the segments within the metaslabs is based on the size of the blocks within the I/O requests. That is, small segments are allocated for small blocks, while large segments are allocated for large blocks. The allocation of segments based on the size of the blocks may allow for more efficient storage of data and metadata in the storage pool by reducing the amount of unused space within a given metaslab. Further, using large segments for large blocks may allow for more efficient access to data (and metadata) by reducing the number of DMU (104) translations and/or reducing the number of I/O operations. In one embodiment of the invention, the metaslab allocator (204) may include a policy that specifies a method to allocate segments.

As noted above, the storage pool (108) is divided into metaslabs, which are further divided into segments. Each of the segments within the metaslab may then be used to store a data block (i.e., data) or an indirect block (i.e., metadata). FIG. 3 shows the hierarchical data configuration (hereinafter referred to as a “tree”) for storing data blocks and indirect blocks within the storage pool in accordance with one embodiment of the invention. In one embodiment of the invention, the tree includes a root block (300), one or more levels of indirect blocks (302, 304, 306), and one or more data blocks (308, 310, 312, 314). In one embodiment of the invention, the location of the root block (300) is in a particular location within the storage pool. The root block (300) typically points to subsequent indirect blocks (302, 304, and 306). In one embodiment of the invention, indirect blocks (302, 304, and 306) may be arrays of block pointers (e.g., 302A, 302B, etc.) that, directly or indirectly, reference to data blocks (308, 310, 312, and 314). The data blocks (308, 310, 312, and 314) contain actual data of files stored in the storage pool. One skilled in the art will appreciate that several layers of indirect blocks may exist between the root block (300) and the data blocks (308, 310, 312, 314).

In contrast to the root block (300), indirect blocks and data blocks may be located anywhere in the storage pool (108 in FIG. 1). In one embodiment of the invention, the root block (300) and each block pointer (e.g., 302A, 302B, etc.) includes data as shown in the expanded block pointer (302B). One skilled in the art will appreciate that data blocks do not include this information; rather data blocks contain actual data of files within the file system.

In one embodiment of the invention, each block pointer includes a metaslab ID (318), an offset (320) within the metaslab, a birth value (322) of the block referenced by the block pointer, and a checksum (324) of the data stored in the block (data block or indirect block) referenced by the block pointer. In one embodiment of the invention, the metaslab ID (318) and offset (320) are used to determine the location of the block (data block or indirect block) in the storage pool. The metaslab ID (318) identifies a particular metaslab. More specifically, the metaslab ID (318) may identify the particular disk (within the storage pool) upon which the metaslab resides and where in the disk the metaslab begins. The offset (320) may then be used to reference a particular segment in the metaslab. In one embodiment of the invention, the data within the segment referenced by the particular metaslab ID (318) and offset (320) may correspond to either a data block or an indirect block. If the data corresponds to an indirect block, then the metaslab ID and offset within a block pointer in the indirect block are extracted and used to locate a subsequent data block or indirect block. The tree may be traversed in this manner to eventually retrieve a requested data block.

In one embodiment of the invention, copy-on-write transactions are performed for every data write request to a file. Specifically, all write requests cause new segments to be allocated for the modified data. Therefore, the retrieved data blocks and indirect blocks are never overwritten (until a modified version of the data block and indirect block is committed). More specifically, the DMU writes out all the modified data blocks in the tree to unused segments within the storage pool. Subsequently, the DMU writes out the corresponding block pointers (within indirect blocks) to unused segments in the storage pool. In one embodiment of the invention, fields (i.e., metaslab ID, offset, birth, checksum) for the corresponding block pointers are populated by the DMU prior to sending an I/O request to the SPA. The indirect blocks containing the block pointers are typically written one level at a time. To complete the copy-on-write transaction, the SPA issues a single write that atomically changes the root block to reference the indirect blocks referencing the modified data block.

In one embodiment of the invention, the birth value (referred to as birth time) does not correspond to a time, but rather a transaction group number (e.g., a sequential numeric value defining a transaction, where all blocks written to the disk in a given transaction group as associated with a transaction group number).

Using the infrastructure shown in FIGS. 1-3, the following discussion describes a method for performing block-based incremental backups of a file system. More specifically, the invention is directed to backing-up a file system in a manner that allows only those parts of the file system that have changed or been modified since the last backup occurred to be backed-up.

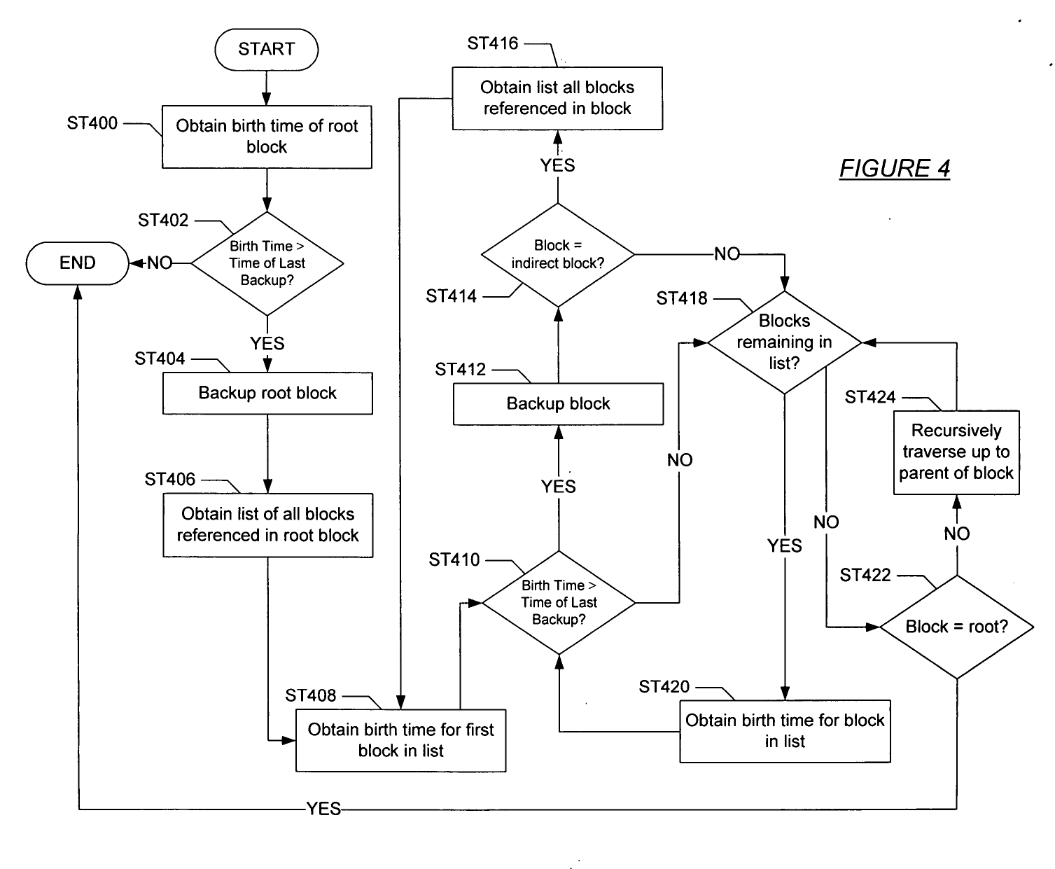

FIG. 4 shows a flow chart for performing a block-based incremental backup in accordance with one embodiment of the invention. In general, the flow chart shown in FIG. 4 provides a method for traversing the hierarchical block tree (e.g., the tree shown in FIG. 3) such that only the branches that include (or could possibly include) a block that includes a birth time after the last incremental backup of the file system was performed. Initially, the birth time of the root block for the file is obtained (Step 400). In one embodiment of the invention, the root block corresponds to a block that is used by the file system to initially access the file.

Subsequently, a determination is made about whether the birth time of the root block is greater than the time of the last backup (full or incremental, whichever was later) was performed on the file system (Step 402). If the birth time of the root block is not greater than the time of the last backup, then the particular file with which the root block is associated has not changed since the last backup of the file system (i.e., no blocks in the hierarchical block tree for that file need to be backed up). Thus, the process ends.

However, if the birth time of the root block for the file is greater than the time of the last backup, then the content stored in the root block is backed up (i.e., copied) (Step 404). Next, a list of all blocks (typically indirect blocks) referenced by the root block is obtained (Step 406). The birth time for the first block on the list is then obtained (Step 408). A determination is then made about whether the birth time of the block is greater than the time of the last backup (full or incremental, whichever was later) (Step 410). If the birth time of the block is not greater than the time of the last backup, then another determination is made about whether any blocks referenced by the root block remain in the list (Step 418). Said another way, because the portion of the hierarchical block tree associated with the block that does not have a birth time after the time of the last backup it does not need to be traversed.

Returning to Step 410, if the birth time of the block is greater than the time of the last backup, then the block (i.e., the block with the birth time obtained in Step 408) is backed up (Step 412). Next, a determination is made about whether the current block (i.e., the block backed up in Step 412) is an indirect block (Step 414). If the current block is not an indirect block (i.e., the block is a data block), then a determination is made about whether any remaining blocks exist in the list (i.e., the list of blocks obtained in Step 406 or 416) (Step 418). If there are no blocks in the list, then a determination is made about whether the block (i.e., the block that is referencing all the blocks on the list queried in Step 418) is the root block (Step 422). If the block is the root block, then the process ends. Alternatively, if the block is not the root block, then the process recursively traverses up the hierarchical block tree to the parent block of the block (Step 424). The process then proceeds to Step 418.

If the current block is an indirect block (Step 414), then a list of all the blocks referenced by the indirect block is obtained (Step 416). Subsequently, Steps 408-418 are repeated to perform the traversal of portions of the hierarchical block tree associated with each block referenced by the indirect block.

Returning to Step 418, if additional blocks referenced by the root block exist, then the birth time for the next block referenced by the root block is obtained (Step 420). Subsequently, Steps 410-418 are repeated to determine whether the contents of the next block need to be backed up.

Those skilled in the art will appreciate that the entire process shown in FIG. 4 is repeated for each file in the file system. That is, the hierarchical block tree representing each file in the file system is traversed in the manner described above to backup only the blocks that have changed since the last back up (full or incremental, whichever was later) of the file system was performed.

Embodiments of the present invention provide a method for finding files that have been modified. That is, files that have not been modified since the last backup (incremental or full) are left untouched, while only the files that have been modified since the last backup are traversed. For example, suppose that the root block is the root of the entire file system, and each indirect block referenced by the root block is the “root” of a file. In this scenario, by examining the birth time of each of the indirect blocks referenced by the root block of the file system, the present invention is able to find only the files that have been modified since the last backup.

In one embodiment of the invention, the aforementioned process for incremental backup of each file in the file system allows the incremental backup process to locate modified files more efficiently because: 1) all the blocks in every file do not need to be examined; and 2) if the file includes one or more blocks that need to be backed up, only the branches which contain those blocks are traversed. Those skilled in the art will appreciate that the aforementioned backup process is made possible by the block-based granularity of the hierarchical tree structure that represents each file in the file system.

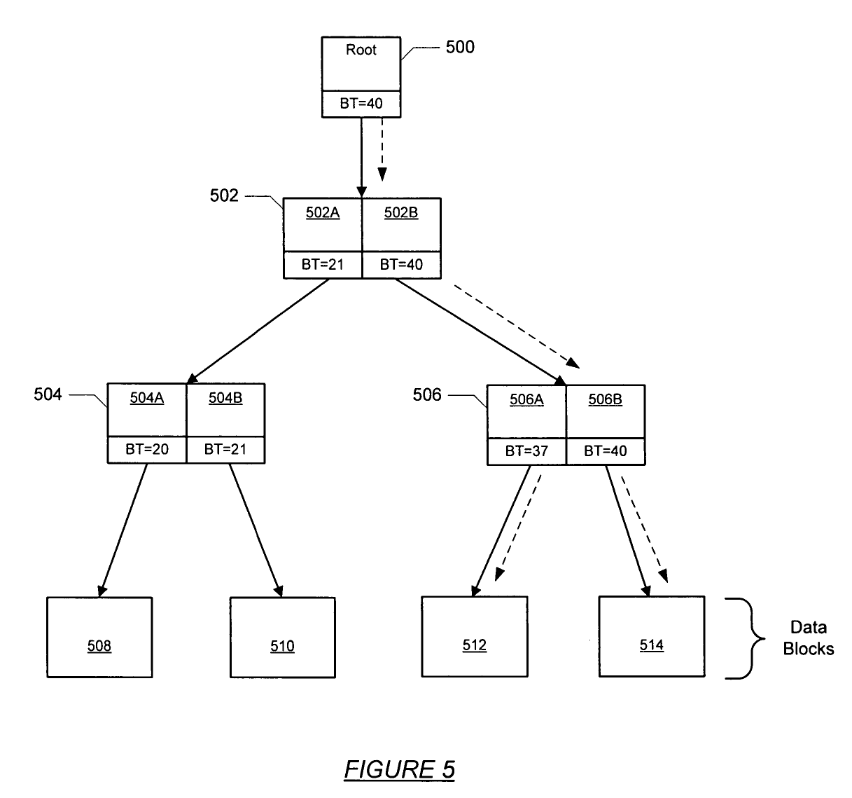

FIG. 5 shows an example of block-based incremental backup in accordance with one embodiment of the invention. More specifically, FIG. 5 shows an example of applying the method described in FIG. 4. For purposes of the example shown in FIG. 5, assume that the last backup (full or incremental, which ever was later) was performed at time 35 (i.e., T=35). The dotted arrows in FIG. 5 represent the portion(s) of the hierarchical block tree that are traversed to backup a file for purposes of this example.

The following is a description of the steps, in accordance with one embodiment of the invention, that may be taken to perform an incremental backup the hierarchical block tree shown in FIG. 5. Initially, the birth time (BT) of the root block (500) of the file represented by the hierarchical block tree is obtained. In the example of FIG. 5, the root block (500) represents the root of a file; however, as described above, the root block (500) may be an indirect block referenced by the root block of the file system. Although the birth time of the root block (500) is not shown in FIG. 5, consider the scenario in which the birth time of the root block (500) is after that of the last backup (i.e., after T=35). Thus, the backup process for this particular file must continue, because there are potentially blocks in this file that have been changed/modified since the last backup was performed. Those skilled in the art will appreciate that if the birth time of the root block (500) is not subsequent to the last backup (incremental or full), then the traversal of the file is not necessary, because the file has not been modified since the last backup. In this manner, embodiments of the invention provide for a method for determining whether a file has been modified since the last backup.

Continuing with FIG. 5, because the birth time of the root block (500) is after that of the last backup, the content of the root block (500) is backed up. Subsequently, a list of blocks referenced by the root block (500) is obtained. In this example, the root block (500) references indirect block (502). At this stage, the birth time of the indirect block (502) is obtained from the root block (500). Specifically, FIG. 5 shows the birth time of the indirect block (502) stored in the root block (500) (i.e., BT=40). Next, the birth time of indirect block (502) is compared with the time of the last backup of the file system. Again, because the birth time of the indirect block (502) is after the time of the last backup of the file system, the content of the indirect block (502) is backed up.

Upon backing up the content of the indirect block (502), a list of blocks referenced by the indirect block (502) is obtained. In this example, indirect block (502) references two other indirect blocks (i.e., indirect block (504) and indirect block (506)). Subsequently, the birth time of the first block referenced by indirect block (502) is obtained. In this case, the birth time of indirect block (504) is BT=21, which is before the last backup was performed. Thus, the content of indirect block (504) was backed up during the previous backup of the file system and has not changed since that time. Thus, the content of indirect block (504) does not need to be backed up during the current backup.

As a result, the left branch of the hierarchical block tree that follows from indirect block (502) does not need to be traversed any further to search for blocks that need to be backed up in the current backup. Thus, the process returns to indirect block (502), where the birth time of next referenced block is obtained from the list of blocks referenced by indirect block (502). In this example, the birth time of indirect block (506) is BT=40, which is subsequent to the time of the last backup. Thus, the content of indirect block (506) is backed up. Subsequently, a list of blocks referenced by indirect block (506) is obtained. In this example, indirect block (506) references two data blocks (i.e., data block (512) and data block (514)). Thus, the birth time of the first referenced data block (512) is obtained and compared to the time of the last backup. Because the birth time of data block (512) (BT=37) is after the time of the last backup, the content of data block (512) is backed up. Now, because there are no blocks referenced by data blocks, the process returns to the parent block of data block (512), which is indirect block (506) to determine whether any additional blocks referenced by indirect block (506) exist.

Indirect block (506) also references data block (514). The birth time of data block (514) is also subsequent to the time of the last backup (BT=40). Thus, the contents of data block (514) is backed up. At this stage, a determination is made whether the parent block of data block (514) references any additional blocks. Because indirect block (506) does not reference any additional blocks, the process continues up the hierarchical block tree to the parent of indirect block (506), where the same determination is made. Again, indirect block (502) does not reference any additional blocks, so the process returns to the root block (500). Upon reaching the root block, a determination is made whether the root block (500) references any additional blocks. Because the root block (500) does not reference any additional blocks, the traversal of the hierarchical block tree is complete.

Those skilled in the art will appreciate that by using the process discussed in FIG. 4 to backup a hierarchical block tree, only the portions of the hierarchical block tree that are modified after the last backup was performed are traversed. Further, those skilled in the art will appreciate that the description of the example in FIG. 5 may represent one file in the file system that is being ly backed up. Thus, the aforementioned process may be repeated for each file in the file system.

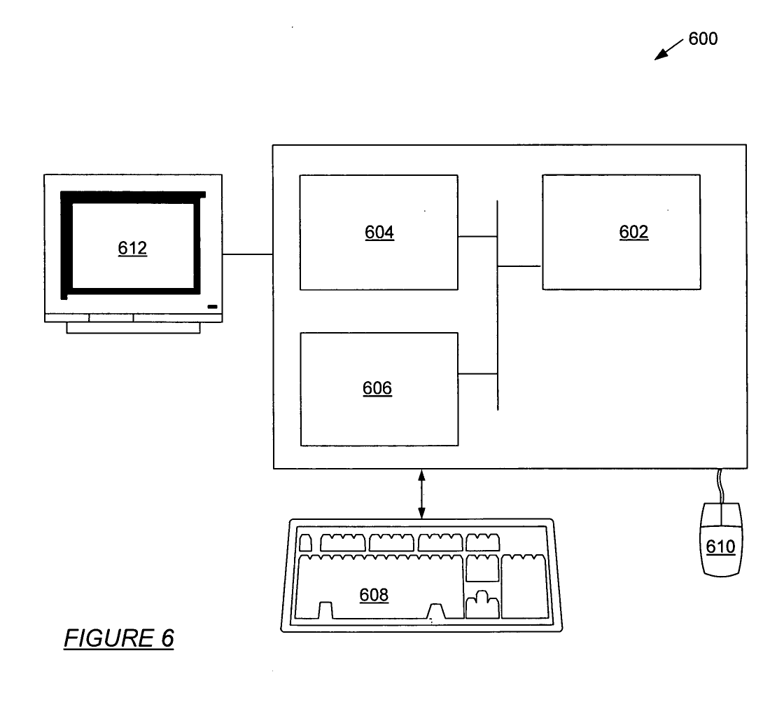

The invention may be implemented on virtually any type of computer regardless of the platform being used. For example, as shown in FIG. 6, a networked computer system (600) includes a processor (602), associated memory (604), a storage device (606), and numerous other elements and functionalities typical of today's computers (not shown). The networked computer system (600) may also include input means, such as a keyboard (608) and a mouse (610), and output means, such as a monitor (612). The networked computer system (600) is connected to a local area network (LAN) or a wide area network (e.g., the Internet) (not shown) via a network interface connection (not shown). Those skilled in the art will appreciate that these input and output means may take other forms. Further, those skilled in the art will appreciate that one or more elements of the aforementioned computer (600) may be located at a remote location and connected to the other elements over a network. Further, the invention may be implemented on a distributed system having a plurality of nodes, where each portion of the invention (e.g., the storage pool, the SPA, the DMU, etc.) may be located on a different node within the distributed system. In one embodiment of the invention, the node corresponds to a computer system. Alternatively, the node may correspond to a processor with associated physical memory.

Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for backing up a file system, comprising:
obtaining a first indirect block comprising a first block pointer;
obtaining a first birth time from the first block pointer;
determining whether the first birth time is subsequent to a time of a last backup; and
backing up a first block referenced by the first block pointer, if the first birth time is subsequent to the time of the last backup.

2. The method of claim 1, further comprising:
if the first birth time is not subsequent to the time of the last backup and the first indirect block comprises a second block pointer:
obtaining a second birth time associated with a second block from the second block pointer;
determining whether the second birth time is subsequent to the time of the last backup; and
backing up the second block, if the second birth time is subsequent to the time of the last backup.

3. The method of claim 1, wherein the first birth time corresponds to a transaction group associated with an input/output request to store the first indirect block.

4. The method of claim 1, wherein the first indirect block is associated with a file in the file system.

5. The method of claim 4, wherein the last backup corresponds to an incremental backup of the file.

6. The method of claim 1, wherein the last backup corresponds to a full backup of the file system.

7. The method of claim 1, wherein the first block is a data block.

8. A system for backing up a file in a file system, comprising:
the file comprising:
a plurality of data blocks and at least one indirect block, wherein the indirect block comprises a birth time associated with at least one of the plurality of data blocks, and
a root block comprising a birth time associated with the at least one indirect block;
a storage pool allocator configured to store the plurality of data blocks, the at least one indirect block, and the root block on a disk,
wherein the root block is backed up if a birth time associated with the root block is after a time of a last backup,
wherein the at least one indirect block is backed up if a birth time of the at least one indirect block is after the time of the last backup, and
wherein only the ones of the plurality of data blocks having a birth time after the time of the last backup are backed up.

9. The system of claim 8, wherein the birth time associated with the at least one indirect block corresponds to a transaction group associated with an input/output request to store the at least one indirect block.

10. The system of claim 8, wherein the at least one indirect block is obtained by examining a list of indirect blocks referenced by the root block of the file.

11. The system of claim 8, wherein the last backup corresponds to an incremental backup of the file.

12. The system of claim 8, wherein the last backup corresponds to a full backup of the file system.

13. The system of claim 8, wherein the plurality of data blocks, the at least one indirect block, and the root block are organized in a hierarchical tree structure.

14. A computer usable medium comprising computer readable program code embodied therein for causing a computer system to:
obtain a first indirect block comprising a first block pointer;
obtain a first birth time from the first block pointer;
determine whether the first birth time is subsequent to a time of a last backup; and
back up a first block referenced by the first block pointer, if the first birth time is subsequent to the time of the last backup.

15. The computer usable medium of claim 14, further comprising computer readable program code embodied therein for causing a computer system to:
if the first birth time is not subsequent to the time of the last backup and the first indirect block comprises a second block pointer:
obtain a second birth time associated with a second block from the second block pointer;
determine whether the second birth time is subsequent to the time of the last backup; and
back up the second block, if the second birth time is subsequent to the time of the last backup.

16. The computer usable medium of claim 14, wherein the first birth time corresponds to a transaction group associated with an input/output request to store the first indirect block.

17. The computer usable medium of claim 14, wherein the first indirect block is associated with a file in the file system.

18. The computer usable medium of claim 17, wherein the last backup corresponds to an incremental backup of the file.

19. The computer usable medium of claim 14, wherein the last backup corresponds to a full backup of a file system.

20. The computer usable medium of claim 14, wherein the first block is a data block.
